(19) United States
(12) Patent Application Publication
(10) Pub. No.: US 2003/0170061 A1
(43) Pub. Date: Sep. 11, 2003

(54) Keyboard input device

(75) Inventor: Hideki Ito, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/383,357

(22) Filed: Mar. 6, 2003

(30) Foreign Application Priority Data
Mar. 11, 2002 (JP) 2002-065485

(51) Int. Cl. B41J 5/10

(52) U.S. Cl. 400/472

(57) ABSTRACT

A keyboard input device comprises a lever-mounting plate for supporting the lower ends of a pair of lever members in an engaged manner, a circuit board on which the lever-mounting plate is placed and is forming a circuit pattern on a surface facing the lever-mounting plate, a hollow rubber spring adhered onto the circuit board, and a key top supported by the pair of lever members and is urged by the elastic urging force of the rubber spring in a direction to separate away from the circuit board, wherein the circuit board has an insulating layer for insulating and covering the circuit pattern, the insulating layer having a surface area larger than that of the lever-mounting plate permitting the lever-mounting plate to be placed thereon via an uppermost layer.

### BACKGROUND OF THE INVENTION

1. Field of the Invention

This invention relates to keyboard input device and, particularly, to a keyboard input device used as an input device for personal computers.

2. Description of the Related Art

Thin keyboard input devices usually adapted to notebook type personal computers, have been proposed in a variety of kinds in which a pair of lever members are intersecting being linked together so as to serve as members for supporting the key tops and being resiliently urged upward by hollow rubber springs, in a manner that the intersecting angles of the pair of lever members that are linked together vary accompanying the ascending/descending motion of the key tops.

There has been proposed a keyboard input device in which, for example, a lever member of which the upper end is rotatably engaged with the back surface of the key top and another lever member of which the upper end is slidably engaged with the back surface of the key top, are linked together at their intersecting portions, and the key tops are supported by the pair of integrated lever members so as to be moved up and down.

Referring to FIG. 6, the switching unit of the keyboard input device of this kind has a dome-like hollow rubber spring 21, and wherein a moving contact 21b is formed at the ceiling portion 21a in the cavity of the rubber spring 21.

The rubber spring 21 is adhered to a switch board 22 with an adhesive over the whole circumference of a lower end 21d of a skirt-like outer peripheral wall 21c thereof.

The switching board 22 has a pair of fixed contacts 22a and 22a at a portion facing the moving contact 21b so as to produce the switching operation upon contacted by the moving contact 21b.

In the switching board 22, further, a first circuit pattern 22b and a second circuit pattern 22c that are running being connected to the pair of fixed contacts 22a and 22a, are partly laminated in two layers as shown in FIG. 7.

The first circuit pattern 22b is provided with a first insulating layer 23 comprising two resist layers covering the upper portion thereof. On the first insulating layer 23 is formed a second circuit pattern 22c traversing (crossing) the first circuit pattern 22b, and on the second-circuit pattern 22c is formed a second insulating layer 24.

The first and second circuit patterns 23b and 23c which are locally formed in two layers, inclusive of the first and second insulating layers 23 and 24, are protruding having a height A from the surface of the switching board 22.

Even when the first circuit pattern 22b of a single layer is formed as shown in FIG. 8, the switching board 22 protrudes to a height B though it is smaller than the height A.

On the switching board 22 of a portion to where the rubber spring 21 is adhered, further, there is placed a lever-mounting plate 25 mounting a pair of lever members (not shown) intersecting in an X shape being linked together so as to ascend and descend.

As shown in FIGS. 7 and 8, the lever-mounting plate 25 is placed on the first and second circuit patterns 22b and 22c of the two-layer structure, or on the first circuit pattern 22b of the one-layer structure.

Th switching board 22 mounting the above lever-mounting plate 25 is placed on a flat metal plate 26 and is supported in a housing that is not shown.

In the above conventional keyboard input device, when the key top (not shown) on the rubber spring 21 is pushed down, the outer peripheral wall 21c of the rubber spring 21 undergoes the elastic deformation permitting the moving contact 21b to descend.

Then, the moving contact 21b comes in contact with the pair of fixed contacts 22a to turn the switch on.

In the conventional keyboard input device in which the lever-mounting plate 25 is mounted on the insulating layers 23 and 24 that are partly protruding maintaining a height A or B above the surface of the switching board 22, however, the attitude of the lever-mounting plate 25 loses stability, the lever-mounting plate 25 rattles when the key top is depressed, and the feeling for depressing the key top is deteriorated.

Besides, since the first and second insulating layers 23 and 24 are protruding to a height of A or B, a depression of the key top causes the load of depression to be locally and repetitively exerted on the first and second insulating layers 23 and 24.

Due to the load of depression locally and repetitively exerted, therefore, cracks develop in the first and second insulating layers 23 and 24, whereby the second circuit pattern 22c formed on the first insulating layer 23 is broken and the breakdown voltage characteristics are deteriorated.

Or, water infiltrates through the cracks causing the first and second circuit patterns 22b and 22c to be corroded and broken.

### SUMMARY OF THE INVENTION

This invention was accomplished in view of the above problems, and has an object of providing a keyboard input device of a high quality maintaining good feeling of operation when the key tops are depressed and suppressing the occurrence of cracks in the insulating layers on the circuit patterns.

As a first means for solving the above problem, a keyboard input device of the invention comprises a pair of lever members rotatably coupled at their intersecting portions, a lever-mounting plate for supporting the lower ends of the pair of lever members in an engaged manner, a circuit board on which the lever-mounting plate is placed and is forming a circuit pattern on a surface facing the lever-mounting plate, a hollow rubber spring mounted on the circuit board, and a key top supported by the pair of lever members and is urged by the elastic urging force of the rubber spring in a direction to separate away from the circuit board, wherein the circuit board forms an insulating layer for insulating and covering the circuit pattern, the insulating layer having a surface area larger than that of the lever-mounting plate permitting the lever-mounting plate to be placed thereon.

The insulating layer is constituted by at least two or more resist layers formed being laminated on the circuit board inclusive of the circuit pattern.

The insulating layer forms a protruded portion by causing the resist layer to be protruded on the circuit pattern, a dummy layer of a size equal to the height of the protruded portion is formed on the slope portions around the protruded portion, and an uppermost layer comprising the resist layer is laminated on the dummy layer and on the protruded portion.

### BRIEF DESCRIPTION OF THE DRAWINGS

FIG. 1 is a sectional view illustrating a major portion of a keyboard input device of the invention;

FIG. 2 is a view schematically illustrating how to mount a lever-mounting plate on a circuit board according to the invention;

FIG. 3 is a view illustrating a relationship between the circuit board and the lever-mounting plate according to the invention;

FIG. 4 is a view illustrating a relationship between the circuit board and the lever-mounting plate according to the invention;

FIG. 5 is a view illustrating a relationship between the circuit board and the lever-mounting plate according to the invention;

FIG. 6 is a view illustrating a relationship between the circuit board and the lever-mounting plate according to a prior art;

FIG. 7 is a view illustrating a relationship between the circuit board and the lever-mounting plate according to a prior art; and

FIG. 8 is a view illustrating a relationship between the circuit board and the lever-mounting plate according to a prior art.

### DESCRIPTION OF THE PREFERRED EMBODIMENTS

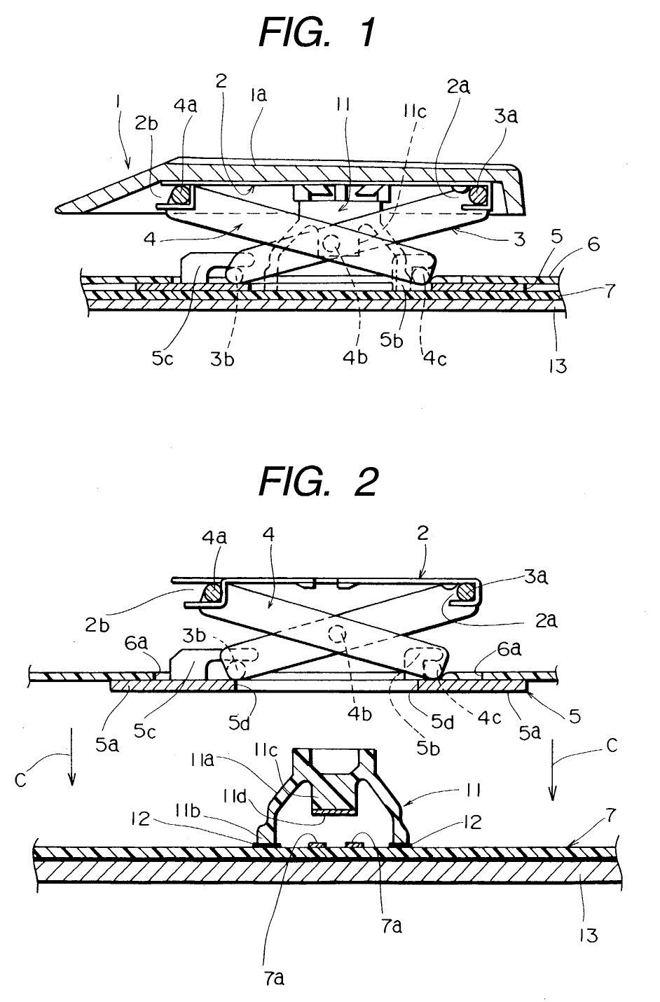

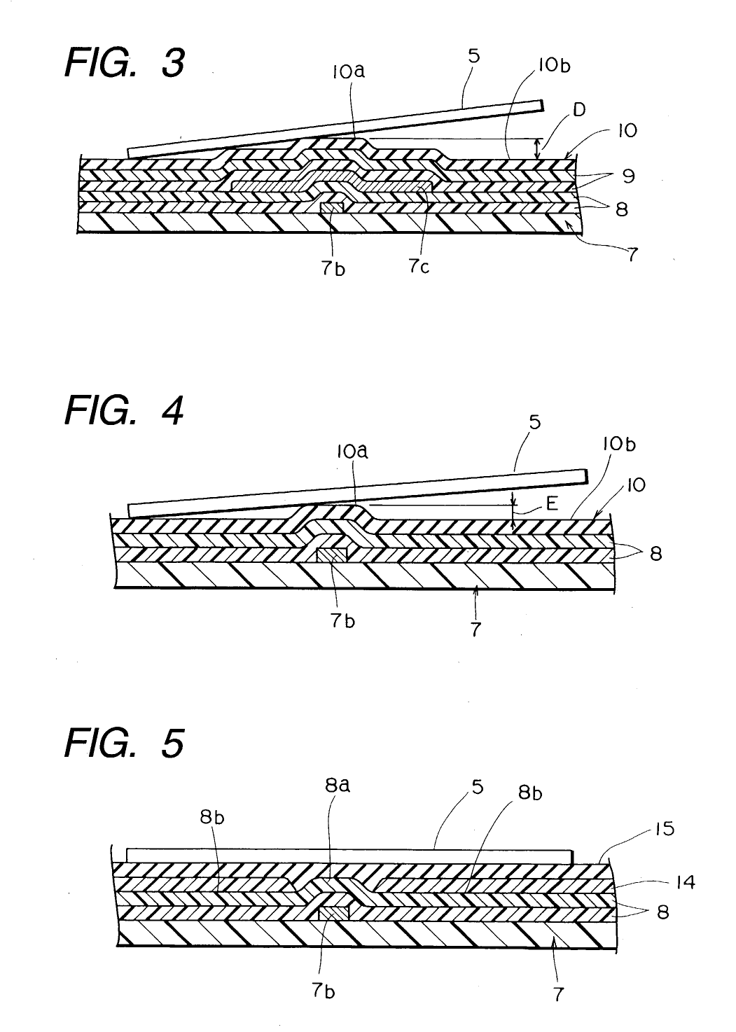

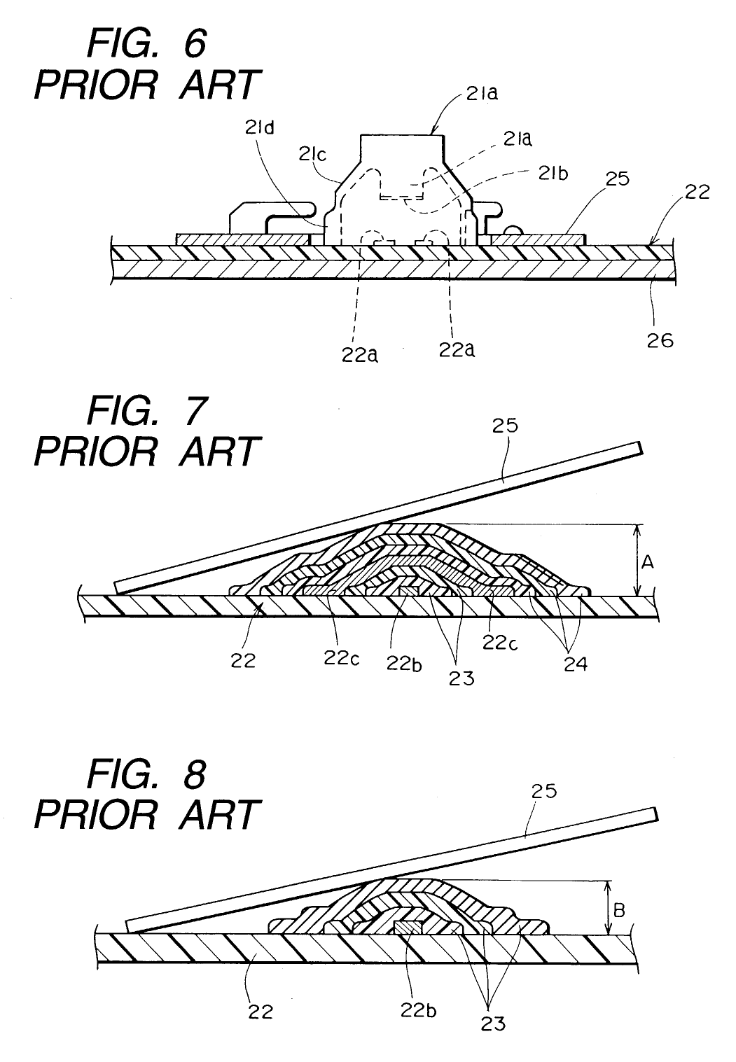

A keyboard input device of the invention will now be described with reference to the drawings. FIG. 1 is a sectional view illustrating a major portion of a keyboard input device of the invention, FIG. 2 is a view schematically illustrating how to mount a lever-mounting plate on a sheet switch according to the invention, and FIGS. 3 and 4 are views illustrating relationships between the circuit board and the lever-mounting plate according to the invention.

Referring, first, to FIG. 1, the keyboard input device of the invention has a key top 1 made of a resin material and arranged at an uppermost part as shown in FIG. 1. On the upper surface of the key top 1 is formed an operation surface la that can be depressed by a finger.

An actuator 2 made of a metal plate such as a stainless steel plate is fastened to the lower surface of the key top 1. The actuator 2 has a rotary engaging portion 2a formed by folding a right end thereof in nearly a U-shape and a slide engaging portion 2b formed by folding a left end thereof in nearly a U-shape.

The rotary engaging portion 2a and the slide engaging portion 2b are opening toward the same left direction in the drawing.

An upper end 3a of a first lever member 3 is rotatably engaged with the rotary engaging portion 2a of the actuator 2, and an upper end 4a of a second lever member 4 is slidably engaged with the slide engaging portion 2b.

The first and second lever members 3 and 4 are linked together so as to turn with a coupling pin 4b at the intersecting portion as a fulcrum.

Upon turning the first and second lever members 3 and 4 with the coupling pin 4b as a fulcrum, the upper ends 3a and 4a vary the distance and move up and down.

Further, the lower ends 3b and 4c of the first and second lever members 3 and 4 are supported by the lever-mounting plate 5.

Referring to FIG. 2, the lever-mounting plate 5 is forming a flat base portion 5a of nearly a rectangular outer shape that is obtained by press-working a metal plate such as of a stainless steel. Further, the right side of the base portion 5a is raised to form a rotary engaging portion 5b of nearly an L-shape. The lower end 4c of the second lever member 4 is rotatably engaged with the rotary engaging portion 5b.

Further, the left side of the base portion 5a is raised to form a slide engaging portion 5c of nearly an L-shape. The lower end 3b of the first lever member 3 is slidably engaged with the slide engaging portion 5c.

The base portion 5a has a circular through hole 5d formed in nearly the central portion thereof so that a rubber spring 8 that will be described later can be inserted therein.

The rotary engaging portion 5b and the slide engaging portion 5c are opening toward the same right direction in the drawing.

At the time of assembling, the lever-mounting plate 5 is temporarily secured to a support plate 6 to constitute a unit.

The support plate 6 has openings 6a by which the lever-mounting plate 5 can be temporarily secured. When a rotary support portion 6b and a slide support portion 5c of the lever-mounting plate 5 are inserted in the openings 6a from the lower side toward the upper side, snap-engaging portions (not shown) formed on the lever-mounting plate 5 are snap-engaged with the openings 6a.

At the same time, further, the right and left both ends of the base portion 5a are brought into contact with the lower surface of the support plate 6, whereby the lever-mounting plate 5 is limited from moving up and down, and is temporarily secured to the support plate 6 due to snap-engagement.

The above lever-mounting plate 5 supports the first and second lever members 3 and 4 that are linked together thereby to assemble a switch unit.

A film-like circuit board 7 is arranged in the lower part of the lever-mounting plate 5 which is temporarily secured to the support plate 6, and a pair of fixed contacts 7a and 7a are formed on one surface of the circuit board 7 facing each other maintaining a predetermined gap.

Referring to FIG. 3, on the circuit board 7 is formed a first circuit pattern 7b which may be a silver pattern or the like pattern that is running being connected to the fixed contact 7a. On the first circuit pattern 7b is formed a first insulating layer 8 constituted by at least two or more resist layers.

The first insulating layer 8 has a surface area larger than that of the lever-mounting plate 5.

On the first insulating layer 8 is formed a second circuit pattern 7c traversing (crossing) the first circuit pattern 7b. A second insulating layer 9 constituted by at least two or more resist layers like the first insulating layer 8, is formed on the second circuit pattern 7c and on the first insulating layer 8 of portions exposed beyond the second circuit pattern 7c.

Like the first insulating layer 8, the second insulating layer 9, too, has a surface area larger than that of the lever-mounting plate 5.

The first and second insulating layers 8 and 9 are constituted by two or more resist layers, respectively, because of the reason that a single resist layer has a limitation on the thickness thereof. In order to seal pinholes that occur at the time of printing resist layers, there are formed at least two or more resist layers. By laminating at least two or more resist layers, further, the respective insulating layers 8 and 9 maintain thickness to exhibit increased mechanical strength. Even when the load of depression is exerted on the key top 1 through the lever-mounting plate 5 placed on the uppermost layer 10 that will be described later, therefore, no crack occur in the insulating layers 8 and 9.

The uppermost layer 10 which is, for example, a black resist layer is formed on the second insulating layer 9. The surface of the uppermost layer 10 can be seen through gaps among the plurality of key tops 1 arranged in the upper part. Therefore, the color is changed to meet the user's requirement.

The uppermost layer 10 has a protruded portion 10a formed on the first circuit pattern 7b being protruded depending upon the thickness of the first circuit pattern 7b.

Further, a slope portion 10b is formed in the periphery of the protruded portion 10a, and a step between the protruded portion 10a and the boundary portion 10b has a height D which is smaller than the heights A and B in the prior art.

Referring to FIG. 4 in which the first circuit pattern 7b only is running, the first insulating layer 8 constituted by two resist layers is formed on the first circuit pattern 7b, and the uppermost layer 10 is formed on the first insulating layer 8.

In the circuit board 7 on which the first circuit pattern 7b only is running, the step between the protruded portion 10aof the uppermost layer 10 and the slope portion 10b has a height E. The height E is nearly equal to the thickness of the first circuit pattern 7b and is smaller than the height D shown in FIG. 3.

A hollow rubber spring 11 having a dome-like outer shape is arranged over the side facing the pair of fixed contacts 7a and 7a.

The rubber spring 11 is formed hollow, is adhered at its skirt-like outer peripheral wall 11a and at the lower end 11b of the outer peripheral wall 11a to the circuit board 7 with an adhesive 12, so that the circuit board 7 and the rubber spring 11 are formed integrally together.

The rubber spring 11 has a moving contact 11d formed of a film of carbon or the like maintaining a predetermined thickness on a ceiling portion 11c in the cavity.

The circuit board 7 forming the rubber spring 11 integrally together is placed on a flat bottom plate 13 made of a metal plate such as aluminum plate.

The bottom plate 13 mounting the circuit board 7 is mounted in a housing that is not shown.

To assemble the keyboard input device of this invention as shown in FIG. 2, the first and second lever members 3 and 4 are supported on the lever-mounting plate 5 to assemble a switching unit.

The lever-mounting plate 5 in the form of a unit is temporarily secured by being snap-engaged with the openings 6a of the support plate 6.

The lower ends 3b, 4c of the first and second lever members 3, 4 are supported by the lever-mounting plate 5 which is temporarily secured to the support plate 6.

Further, the actuator 2 is mounted on the upper ends 3a and 4a of the pair of lever members 3 and 4.

Thereafter, the through hole 5d of the lever-mounting plate 5 is brought to a position of the lower rubber spring 11, and the support plate 6 is lowered as indicated by an arrow C, whereby he lever-mounting plate 5 is positioned on the circuit board 7, and the rubber spring 11 penetrates through the hole 5d so as to protrude upward beyond the lever-mounting plate 5.

Due to the elastic urging force of the rubber spring 11, therefore, the actuator 2 moves upward, and the first and second lever members 3 and 4 are liked together intersecting in an x shape.

Next, the key top 1 is positioned on the actuator 2 and is engaged with the actuator 2 to assemble the keyboard input device of the invention.

In the thus assembled keyboard input device of the invention, when the operation surface 1a of the key top 1 on the rubber spring 11 is depressed down, the outer peripheral wall 8b of the rubber spring 11 undergoes the elastic deformation and the moving contact 8d descends.

Then, the moving contact 8d that has descended comes in contact with the pair of fixed contacts 7a to turn the switching circuit (not shown) on.

When the key top 1 is no longer depressed, the moving contact 8d separates away from the fixed contacts 7a, 7a due to the elastic force of the rubber spring 11, whereby the switching circuit is turned off and the rubber spring 11 returns to the initial state of its original shape.

Further, the protruded portion 10a has a step which is as small as D and the lever-mounting plate 5 is placed on the uppermost layer 10 having a surface area larger than that of the lever-mounting plate 5. Even when the key top 1 is depressed, therefore, the lever-mounting plate 5 rattles little.

Referring to FIG. 5 illustrating another embodiment of the invention, the first circuit pattern 7b only is formed on the circuit board 7. Here, on the first circuit pattern 7b is formed the first insulating layer 8 constituted by two resist layers, a dummy layer 11 of a resist layer having a size nearly the same as the height of the protruded portion 8a is formed on the slope portion 8b surrounding the protruded portion 8a of the first insulating layer 8, and the uppermost layer 15 which is a black resist layer is formed on the dummy layer 11 and on the protruded portion 8a. The dummy layer 11 has a surface area equal to that of the first insulating layer 8.

As shown in FIG. 5, the surface of the uppermost layer 15 can be formed flat. Even when the key top 1 is depressed, therefore, the lever-mounting plate 5 on the uppermost layer 15 does not rattle.

In the embodiment of the invention, the first and second insulating layers 8 and 9 are constituted by two resist layers, respectively. The first and second insulating layers 8 and 9, however, may be constituted by three or more resist layers, respectively.

That is, the first and second insulating layers 8 and 9 may be formed by at least two or more resist layers, respectively.

In the keyboard input device of the invention as described above, an insulating layer is formed for insulating and covering the circuit pattern, the insulating layer having a surface area larger than that of the lever-mounting plate, and the lever-mounting plate is placed on the insulating layer. This makes it possible to lower the height of the protruded portion of the insulating layer formed on the circuit pattern and, hence, to decrease the rattling of the lever-mounting plate when the key top is depressed. Thus, there is provided a keyboard input device featuring excellent key top operability.

The insulating layer is constituted by a plurality of resist layers laminated on the circuit board which includes the circuit pattern. It is therefore made possible to seal the pinholes occurring in the resist layer and to improve the voltage characteristics of the circuit pattern.

Further, the insulating layer has a protruded portion protruding on the circuit pattern depending upon the thickness of the circuit pattern, a dummy layer of a height same as the height of the protruded portion is formed in the slope portion around the protruded portion, and the uppermost layer constituted by a resist layer is laminated on the dummy layer and on the protruded portion, making it easy to flatten the uppermost layer and to reliably prevent the lever-mounting plate from rattling.

Since the lever-mounting plate does not rattle, the load of depression can be dispersed at the time when the key top is depressed.

Accordingly, no crack occurs in the insulating layer and the circuit patterns are not broken.

What is claimed is:

1. A keyboard input device comprising a pair of lever members rotatably coupled at their intersecting portions, a lever-mounting plate for supporting the lower ends of the pair of lever members in an engaged manner, a circuit board on which the lever-mounting plate is placed and is forming a circuit pattern on a surface facing the lever-mounting plate, a hollow rubber spring mounted on the circuit board, and a key top supported by the pair of lever members and is urged by the elastic urging force of the rubber spring in a direction to separate away from the circuit board, wherein the circuit board forms an insulating layer for insulating and covering the circuit pattern, the insulating layer having a surface area larger than that of the lever-mounting plate permitting the lever-mounting plate to be placed thereon.

2. A keyboard input device according to claim 1, wherein the insulating layer is constituted by at least two or more resist layers formed being laminated on the circuit board inclusive of the circuit pattern.

3. A keyboard input device according to claim 2, wherein the insulating layer forms a protruded portion by causing the resist layer to be protruded on the circuit pattern, a dummy layer of a size equal to the height of the protruded portion is formed in the slope portions around the protruded portion, and an uppermost layer comprising the resist layer is laminated on the dummy layer and on the protruded portion.
